(19) United States
(12) Patent Application Publication
(10) Pub. No.: US 2026/0349474 A1
(43) Pub. Date: Nov. 5, 2026

(54) PROTECTION MEMBER, DISPLAY MODULE INCLUDING THE SAME, AND METHOD FOR MANUFACTURING THE DISPLAY MODULE

(71) Applicant: Samsung Display Co., LTD., Yongin-si (KR)

(72) Inventors: SUNGU KIM, Yongin-si (KR); JAECHUN PARK, Yongin-si (KR)

(21) Appl. No.: 19/536,541

(22) Filed: Feb. 11, 2026

(30) Foreign Application Priority Data
Apr. 30, 2025 (KR) 10-2025-0057533

(51) Int. Cl. G06F 1/16; G02F 1/1333

(52) U.S. Cl. CPC G06F 1/1652; G02F 1/133331

(57) ABSTRACT

A display module includes a release film, an adhesive agent, a display member, and a protective film. The release film has a disposition region and an adhesion region defined therein. The adhesive agent is disposed on the adhesion region. The display member includes a circuit layer. The circuit layer is disposed on the disposition region. The protective film includes an adhesive part, a spacing part, and an inclined part. The adhesive prat overlaps with the adhesion region and contacts the adhesive agent. The spacing part overlaps with the disposition region and spaced apart from the display member. The inclined part has one side contacting the adhesive part and another side contacting the spacing part.

This application claims priority to Korean Patent Application No. 10-2025-0057533, filed on Apr. 30, 2025, and all the benefits accruing therefrom under 35 U.S.C. §119, the content of which in its entirety is herein incorporated by reference.

### BACKGROUND

### 1. Field

The disclosure relates to a protection member, a display module including the protection member, and a method for manufacturing the display module. More particularly, the disclosure relates to a protection member including a protective film including an inclined part, a display module including the protection member, and a method for manufacturing the display module.

### 2. Description of the Related Art

A display member consisting of an electronic device may be vulnerable to external factors, such as dust and impact. In case that a display member is transported, for inspection or assembly, for example, the display member may be exposed to external factors. Accordingly, it is desired to protect the protection member for protection of a display member to be transported.

A protection member may include a release film and a protective film. At least a portion of the protective film may be spaced apart from the release film. A display member may be protected by being disposed between the release film and the protective film.

### SUMMARY

The disclosure is to resolve the above problems and relates to a protection member, where a protective film includes an inclined part, thereby eliminating a need for a separate element to space apart a release film and a protective film, a display module including the protection member, and a method for manufacturing the display module.

A display module in an embodiment of the disclosure may include a release film, an adhesive agent, a display member, and a protective film. A disposition region and an adhesion region may be defined in the release film. The adhesive agent may be disposed on the adhesion region. The display member may include a circuit layer, a light-emitting diode layer, and an input sensor unit. The circuit layer may include a plurality of transistors which transmit a signal and be disposed on the disposition region. The light-emitting diode layer may include a plurality of light-emitting diodes which receive a signal to emit light. The light-emitting diode layer may be disposed on the circuit layer. The input sensor unit may be disposed on the light-emitting diode layer and detect an input applied from outside. The protective film may include an adhesive part, a spacing part, and an inclined part. The adhesive part may overlap with the adhesion region and contact the adhesive agent. The spacing part may overlap with the disposition region and be spaced apart from the display member. The inclined part may include one side contacting the adhesive part and another side contacting the spacing part.

In an embodiment of the disclosure, the adhesion region may include a first sub adhesion region and a second sub adhesion region. The second sub adhesion region may be spaced apart from the first sub adhesion region in a first direction. At least a portion of the disposition region may be defined between the first sub adhesion region and the second sub adhesion region. The adhesive agent may include a first sub adhesive agent disposed on the first sub adhesion region, and a second sub adhesive agent disposed on the second sub adhesion region.

In an embodiment of the disclosure, the adhesive part may include a first sub adhesive part, and a second sub adhesive part. The first sub adhesive part may overlap with the first sub adhesion region. The second sub adhesive part may overlap with the second sub adhesion region. The inclined part may include a first sub inclined part, and a second sub inclined part. The first sub inclined part may have one side contacting the first sub adhesive part, and another side contacting the spacing part. The second sub inclined part may have one side contacting the second sub adhesive part, and another side contacting the spacing part. The second sub inclined part may be spaced apart from the first sub inclined part.

In an embodiment of the disclosure, the adhesion region may further include a third sub adhesion region spaced apart from the first sub adhesion region in a direction different from the first direction and spaced apart from the second sub adhesion region. The adhesive agent may further include a third sub adhesive agent disposed on the third sub adhesion region. The adhesive part may further include a third sub adhesive part overlapping with the third sub adhesion region. The inclined part may further include a third sub inclined part having one side contacting the third sub adhesive part and another side contacting the spacing part.

In an embodiment of the disclosure, the protective film may have a folding groove defined therein. The folding groove may be defined as at least any one of a portion where the inclined part and the adhesive part contact each other, and a portion where the inclined part and the spacing part contact each other.

In an embodiment of the disclosure, the first sub inclined part may extend in a first sub inclination direction intersecting with the release film. The second sub inclined part may extend in a second sub inclination direction intersecting with the release film. The first sub inclination direction and the second sub inclination direction may intersect with each other.

In an embodiment of the disclosure, the display member may have a bendable region, which may be bent, defined therein.

In an embodiment of the disclosure, the display member may further include a window member. The window member may be disposed on the input sensor unit. The window member may include a window and a window protection layer. The window may include glass and be bendable. The window protection layer may be disposed on the window.

In an embodiment of the disclosure, a thickness of the window may be greater than or equal to 20 micrometers and less than or equal to 200 micrometers.

In an embodiment of the disclosure, the glass included in the window may be tempered glass.

In an embodiment of the disclosure, the display member may further include a plate. The plate may contact the release film and be disposed between the release film and the circuit layer.

In an embodiment of the disclosure, the bendable region may extend in a bendable direction. The plate may have a bendable slit extending in the bendable direction defined therein.

A protection member in an embodiment of the disclosure may include a release film, an adhesive agent, and a protective film. A disposition region and an adhesion region may be defined in the release film. The adhesive agent may be disposed on the adhesion region. The protective film may be disposed on the release film. The protective film may include an adhesive part, a spacing part, and an inclined part. The adhesive part may overlap with the adhesion region. The adhesive part may contact the adhesive agent. The adhesive part may be spaced apart from the release film by a first spacing distance. The spacing part may overlap with the disposition region. The spacing part may be spaced apart from the release film by a second spacing distance greater than the first spacing distance. The inclined part may have one side contacting the adhesive part, and another side contacting the spacing part. An adhesive force between the adhesive agent and the protective film may be greater than an adhesive force between the adhesive agent and the release film.

In an embodiment of the disclosure, the adhesion region may include a first sub adhesion region and the second sub adhesion region. The second sub adhesion region may be defined to be spaced apart from the first sub adhesion region in a first direction. At least a portion of the disposition region may be defined between the first sub adhesion region and the second sub adhesion region. The adhesive agent may include a first sub adhesive agent and a second sub adhesive agent. The first sub adhesive agent may be disposed on the first sub adhesion region. The second sub adhesive agent may be disposed on the second adhesion region.

In an embodiment of the disclosure, the adhesive part may include a first sub adhesive part and a second adhesive part. The first sub adhesive part may overlap with the first sub adhesion region. The second sub adhesive part may overlap with the second sub adhesion region. The inclined part may include a first sub inclined part and a second sub inclined part. The first sub inclined part may have one side contacting the first sub adhesive part and another side contacting the spacing part. The second sub inclined part may have one side contacting the second sub adhesive part and another side contacting the spacing part. The second sub inclined part may be spaced apart from the first sub inclined part.

In an embodiment of the disclosure, the adhesion region may further include a third sub adhesion region. The third sub adhesion region may be defined to be spaced apart from the first sub adhesion region in a direction different from the first direction. The third sub adhesion region may be defined to be spaced apart from the second sub adhesion region. The adhesive agent may further include a third sub adhesive agent disposed on the third sub adhesion region. The adhesive part may further include a third sub adhesive part overlapping with the third sub adhesion region. The inclined part may further include a third sub inclined part having one side contacting the third sub adhesive part and another side contacting the spacing part.

In an embodiment of the disclosure, the protective film may have a folding groove defined therein. The folding groove may be defined in at least any one of a portion where the inclined part and the adhesive part contact each other and a portion where the inclined part and the spacing part contact each other.

In an embodiment of the disclosure, the first sub inclined part may extend in a first sub inclination direction intersecting with the release film. The second sub inclined part may extend in a second sub inclination direction intersecting with the release film. The first sub inclination direction and the second sub inclination direction may intersect with each other.

A method for manufacturing a display module in an embodiment of the disclosure may include disposing a release film, disposing a display member, and attaching a protective film. A disposition region and an adhesion region may be defined in the release film. In the disposing a display member, a member overlapping with the disposition region may be disposed. The display member may include a circuit layer, a light-emitting diode layer, and an input sensor unit. The circuit layer may include a plurality of transistors which transmit a signal. The light-emitting diode layer may include a plurality of light-emitting diodes and be disposed on the circuit layer. The input sensor unit may be disposed on the light-emitting diode layer and detect an input applied from outside. In the attaching a protective film, an adhesive agent disposed on the adhesion region and a protective film having at least a portion contacting the adhesive agent may be disposed. The protective film may include an adhesive part, a spacing part, and an inclined part. The adhesive part may overlap with the adhesion region and contact the adhesive agent. The spacing part may overlap with the disposition region and spaced apart from the display member. The inclined part may extend in a direction intersecting with the release film.

In an embodiment of the disclosure, inspecting a display member may further included. In the inspecting the display member, an image of the display member may be inspected. The inspecting the display member may be performed after the disposing the display member, and before the attaching the protective film.

In an embodiment of the disclosure, the disclosure provides a protection member, where a protective film includes an inclined part, thereby eliminating a need for a separate element for spacing apart a release film and the protective film, a display module including the protection member, and a method for manufacturing the display module.

### BRIEF DESCRIPTION OF THE DRAWINGS

These and/or other features will become apparent and more readily appreciated from the following description of the embodiments, taken in conjunction with the accompanying drawings in which:

FIG. 1 is an exemplary illustration of an embodiment of a protection member according to the disclosure;

FIG. 2 is an exemplary illustration of an embodiment of a display module according to the disclosure;

FIG. 3A is an exemplary top view of an embodiment of a display module of the disclosure;

FIG. 3B is an exemplary cross-sectional view of a display module taken along the I-I’ line shown in FIG. 3A;

FIG. 3C is an exemplary cross-sectional view of a display module taken along the II-II’ line shown in FIG. 3A;

FIG. 4 is an exemplary cross-sectional view of an embodiment of a display member of the disclosure;

FIG. 5A is an exemplary cross-sectional view of a display module;

FIG. 5B is an exemplary magnified view of the AA area shown in FIG. 5A;

FIG. 6 is an exemplary cross-sectional view of a display module;

FIG. 7 is an exemplary flow chart of an embodiment of a method for manufacturing a display module according to the disclosure; and

FIGS. 8A-8C are each schematic top views illustrating an embodiment of an operation of a method for manufacturing a display module of the disclosure.

### DETAILED DESCRIPTION

References will now be made in detail to illustrative embodiments, of which examples are illustrated in the accompanying drawings, where like reference numerals refer to like elements throughout. The embodiments may have a variety of forms and permutations, but the disclosure shall by no means be construed as being limited to the described embodiments. Rather, the disclosure shall be construed to encompass all forms, permutations, equivalents and substitutes covered by the technical ideas and scope of the disclosure. Accordingly, the embodiments are merely described below, by referring to the drawing figures, to explain features of the disclosure.

Like or identical reference numerals refer to like or identical elements. Moreover, in the accompanying drawings, the thicknesses, ratios, and dimensions of the elements may not be to exact scale and may have been exaggerated for the benefit of effective explanation of the technical features associated with these elements. As such, the disclosure shall not be restricted to the thicknesses, ratios, dimensions, etc. illustrated in the drawings.

An expression such as “comprising” or “including” is intended to designate a characteristic, a number, a step, an operation, an element, a part or combinations thereof, and shall not be construed to preclude any possibility of presence or addition of one or more other characteristics, numbers, steps, operations, elements, parts or combinations thereof.

A term, such as “overlapping,” refers to disposition on a normal direction of a surface of a component without being limited to disposition on or below the surface.

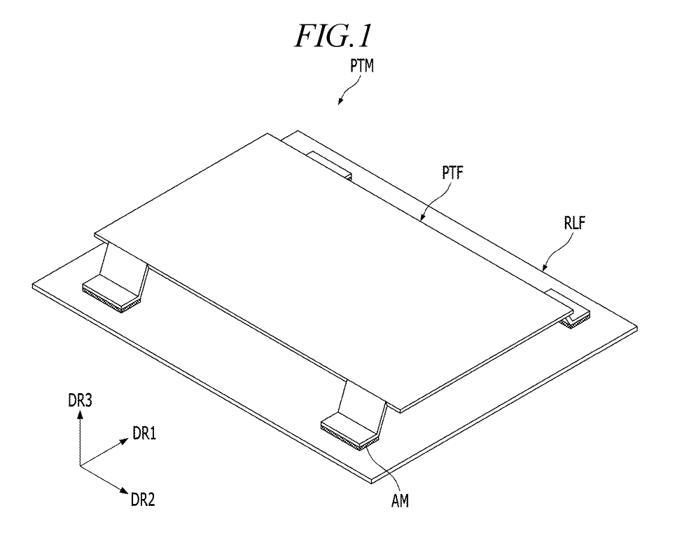

FIG. 1 is an exemplary illustration of an embodiment of a protection member PTM according to the disclosure.

Referring to FIG. 1, the protection member PTM may include a release film RLF, an adhesive agent AM, and a protective film PTF. The protection member PTM may protect a member disposed between the release film RLF and the protective film PTF. In an embodiment, the protection member PTM may protect a display member disposed between the release film RLF and the protective film PTF, for example.

The release film RLF may extend in a direction directed by a first directional axis DR1 and a direction directed by a second directional axis DR2. A normal direction of the release film, i.e., a thickness direction of the release film RLF, may be directed by a third directional axis DR3.

Directions pointed by the first through the third directional axes DR1, DR2 and DR3 are merely a relative concept and may be converted into other directions. Hereinafter, a first through a third directions DR1, DR2 and DR3 are directions pointed by the first through the third directional axes DR1, DR2 and DR3, respectively, and described with the same figure references.

The adhesive agent AM may be disposed on the release film RLF. The adhesive agent AM may attach the release film and a member disposed on the adhesive agent AM. The member disposed on the adhesive agent AM may be the protective film PTF. The adhesive agent AM may attach the release film RLF and the protective film PTF.

The adhesive agent AM may include an acryl-based polymer. The adhesive agent AM may include a pressure-sensitive adhesive agent. The pressure-sensitive adhesive agent may be an acryl-based pressure-sensitive adhesive agent. An adhesive force between the adhesive agent AM and the release film RLF may be weaker than an adhesive force between the adhesive agent AM and the protective film PTF. Accordingly, incase that the protective film PTF is separated from the release film RLF, the adhesive agent AM may remain attached to the protective film PTF and separated from the release film RLF together with the protective film PTF. A thickness of the adhesive agent AM may be greater than or equal to 15 micrometers and smaller than or equal to 35 micrometers. However, a thickness of the adhesive agent AM is not limited to the range of greater than or equal to 15 micrometers and smaller than or equal to 35 micrometers.

At least a portion of the protective film PTF may be disposed on the adhesive agent AM. The protective film PTF may be transparent. The protective film PTF may include an inclined part. Due to the inclined part, at least a portion of the protective film PTF may be spaced apart from the release film RLF. Due to the inclined part, a space between the protective film PTF and the release film RLF may be formed. Accordingly, a member disposed between the protective film PTF and the release film RLF may be protected.

The protective film PTF may be formed by lamination of a lower anti-static layer, a base film, and an upper anti-static layer. The lower anti-static layer and the upper anti-static layer may prevent accumulation of static electricity. The lower anti-static layer and the upper anti-static layer may rapidly dissipate static electricity. Accordingly, an approach of a foreign substance to the protective film PTF due to the electrostatic force generated by the protective film PTF may be prevented. In addition, an exposure of a member disposed between the release film RLF and the protective film PTF to static electricity generated by the protective film PTF may be prevented.

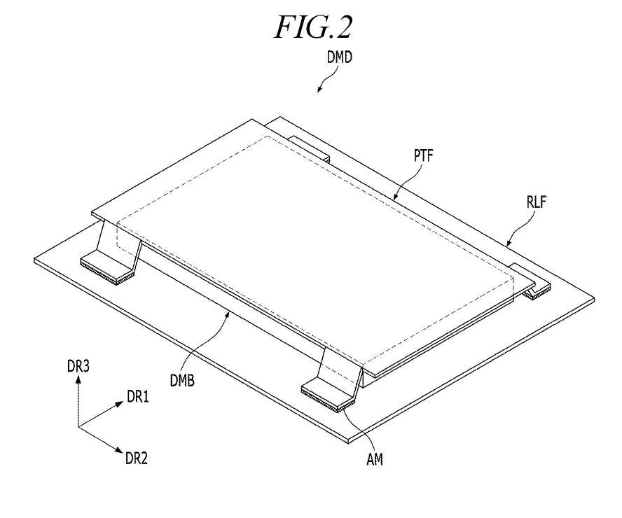

FIG. 2 is an exemplary illustration of an embodiment of a display module DMD according to the disclosure.

Referring to FIG. 2, the display module DMD may include a release film RLF, an adhesive agent AM, a protective film PTF, and a display member DMB. The display member DMB may be disposed between the release film RLF, and the protective film PTF. Accordingly, the display member DMB may be protected from an external factor. The display member DMB may include a display panel. The external factor may include dust and impact, for example.

The release film RLF may be a same release film as the release film RLF shown in FIG. .1. The display module DMD may be disposed between the release film RLF and the protective film PTF of the protection member PTM shown in FIG. 1. Accordingly, the release film RLF shown in FIG. 2 may be a same release film as the release film RLF shown in FIG. .1.

The release film RLF may be a different release film from the release film RLF shown in FIG. 1. The display module DMD may be formed by disposing the display module DMD on the release film RLF shown in FIG. 2 and disposing the protective film PTF and the adhesive agent AM separated from the release film RLF shown in FIG. .1. on the release film RLF shown in FIG. 2. The release film RLF shown in FIG. 2 may extend in the first direction DR1 and the second direction DR2.

The adhesive agent AM may be a same adhesive agent as the adhesive agent AM shown in FIG. 1. An adhesive force between the adhesive agent AM and the release film RLF shown in FIG. 2 may be weaker than an adhesive force between the adhesive agent AM and the protective film PTF. Accordingly, in case that the protective film PTF is separated from the release film RLF shown in FIG. 2, the adhesive agent AM may remain attached to the protective film PTF and separated from the release film RLF together with the protective film PTF.

The protective film PTF may be a same protective film as the protective film PTF shown in FIG. 1. The release film RLF, the adhesive agent AM and the protective film PTF shown in FIG. 2 may compose of the protection member PTM shown in FIG. 1. Descriptions about the release film RLF, the adhesive agent AM, and the protective film PTF of the display module DMD to be described below may equally apply to the release film RLF, the adhesive agent AM, and the protective film PTF of the protection member PTM.

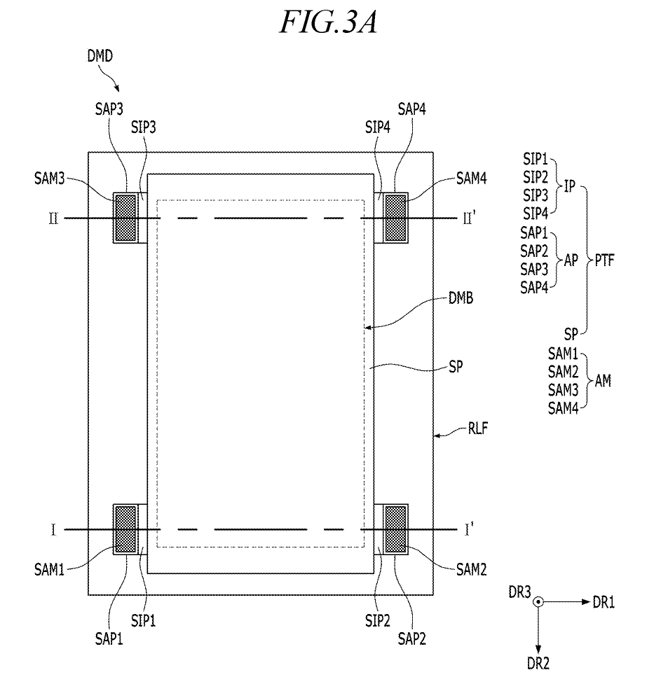

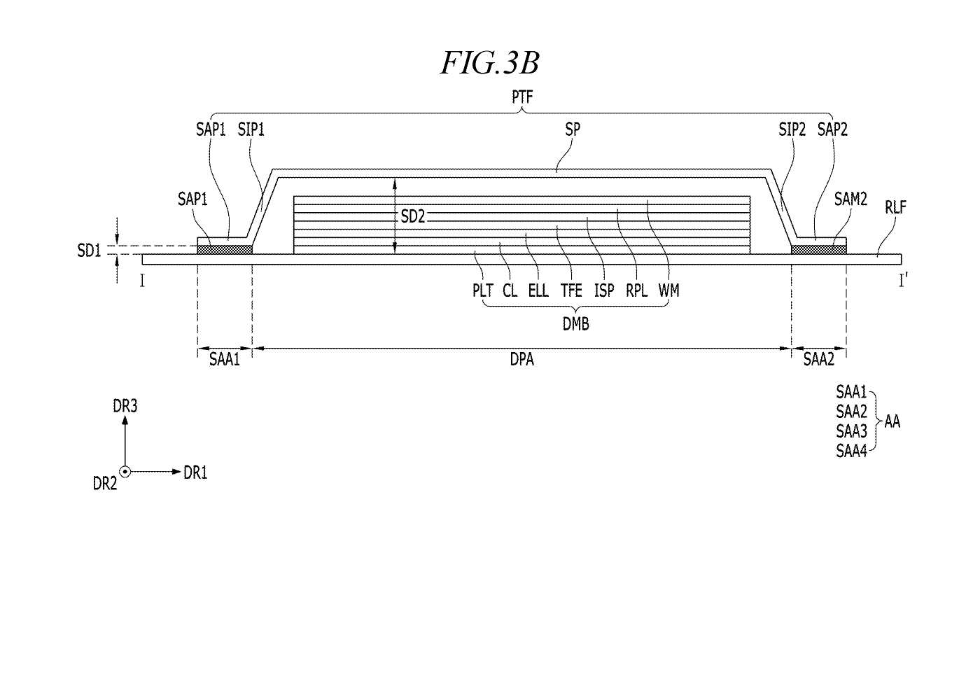

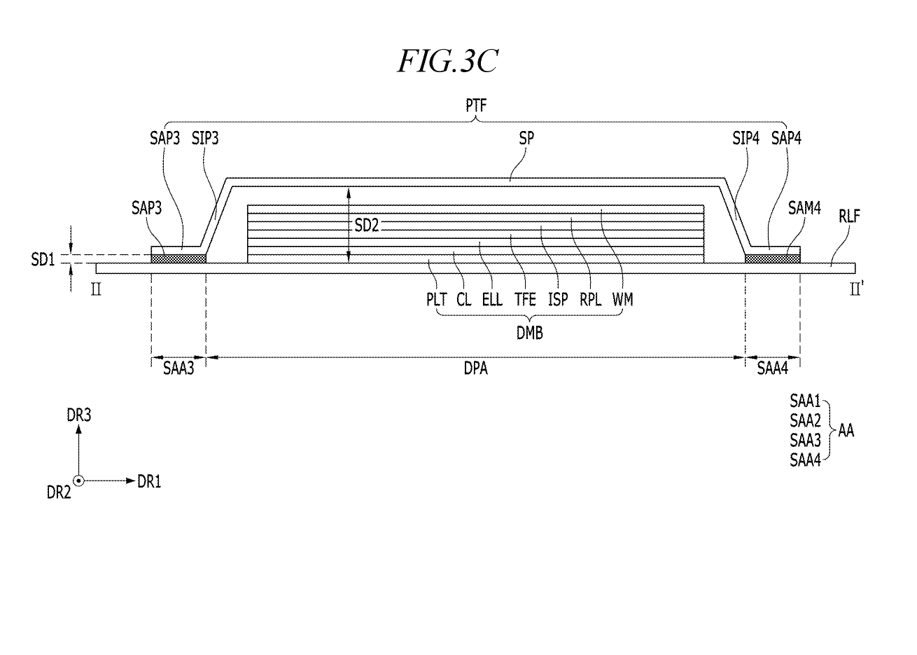

FIG. 3A is an exemplary top view of an embodiment of a display module DMD of the disclosure. FIG. 3B is an exemplary cross-sectional view of a display module DMD taken along the I-I’ line shown in FIG. 3A. FIG. 3C is an exemplary cross-sectional view of a display module DMD taken along the II-II’ line shown in FIG. 3A.

Referring to FIG. 3A, the adhesive agent AM may include a plurality of sub adhesive agents SAM1, SAM2, SAM3, SAM4. The protective film PTF may include an adhesive part AP, an inclined part IP, and a spacing part SP.

The plurality of sub adhesive agents SAM1, SAM2, SAM3, SAM4 may be spaced apart from one another. A second sub adhesive agent SAM2 may be spaced apart from a first sub adhesive agent SAM1 in the first direction DR1. A third sub adhesive agent SAM3 may be spaced apart from the first sub adhesive agent SAM1 in a direction different from the first direction DR1. In an embodiment, the third sub adhesive agent SAM3 may be spaced apart from the first sub adhesive agent SAM1 in the second direction DR2, for example. A fourth sub adhesive agent SAM4 may be spaced apart from the third sub adhesive agent SAM3 in the first direction DR1. The fourth adhesive agent SAM4 may not be provided.

The adhesive part AP may include a plurality of sub adhesive parts SAP1, SAP2, SAP3, SAP4. The adhesive part AP may be disposed on the adhesive agent AM. At least a portion of the adhesive part AP may contact the adhesive agent AM.

The plurality of sub adhesive parts SAP1, SAP2, SAP3, SAP4 may be spaced apart from one another. The plurality of sub adhesive parts SAP1, SAP2, SAP3, SAP4 may be respectively disposed on a corresponding sub adhesive agent SAM1, SAM2, SAM3, SAM4 among the plurality of sub adhesive agents SAM1, SAM2, SAM3, SAM4.

A first sub adhesive part SAP1 may be disposed on a first sub adhesive agent SAM1. A second sub adhesive part SAP2 may be disposed on a second sub adhesive agent SAM2. A third sub adhesive part SAP3 may be disposed on a third sub adhesive agent SAM3. A fourth sub adhesive part SAP4 may be disposed on a fourth sub adhesive agent SAM4. In case that the fourth sub adhesive agent SAM4 is not provided, the fourth sub adhesive part SAP4 may also not be provided.

The inclined part IP may include a plurality of sub inclined parts SIP1, SIP2, SIP3, SIP4. One side of the inclined part IP may contact the adhesive part AP. Another side of the inclined part IP may contact the spacing part SP.

The plurality of sub inclined parts SIP1, SIP2, SIP3, SIP4 may each have one side contacting a corresponding sub adhesive part SAP1, SAP2, SAP3, SAP4 among the plurality of sub adhesive parts SAP1, SAP2, SAP3, SAP4. The plurality of sub inclined parts SIP1, SIP2, SIP3, SIP4 may each have another side contacting the spacing part SP.

One side of a first sub inclined part SIP1 may contact the first sub adhesive part SAP1. One side of a second sub inclined part sIP2 may contact the second sub adhesive part SAP2. One side of a third sub inclined part SIP3 may contact the third sub adhesive part SAP3. One side of a fourth sub inclined part SIP4 may contact the fourth sub adhesive part SAP4. In case that the fourth sub adhesive agent SAM4 is not provided, the fourth sub inclined part sIP4 may also not be provided.

At least a portion of The spacing part SP may be disposed on the display member DMB. The spacing part SP may be spaced apart from the display member DMB. At least a portion of The spacing part SP may overlap with the display member DMB.

Referring to FIGS. 3B and 3C, the release film RLF may have an adhesion region AA and a disposition region DPA defined therein.

The adhesion region AA may include a plurality of sub adhesion regions SAA1, SAA2, SAA3, SAA4. The adhesive agent AM may be disposed on the adhesion region AA.

The first sub adhesive agent SAM1 may be disposed on a first sub adhesion region sAA1. The first sub adhesive agent SAM1 may overlap with the first sub adhesion region SAA1.

The second sub adhesive agent SAM2 may be disposed on a second sub adhesion region SAA2. The second sub adhesion region SAA2 may be spaced apart from the first sub adhesion region SAA1 in the first direction DR1. The second sub adhesive agent SAM2 may overlap with the second sub adhesion region SAA2.

The third sub adhesive agent Sam3 may be disposed on a third sub adhesion region SAA3. The third sub adhesion region SAA3 may be spaced apart from the first sub adhesion region SAA1 in a direction different from the first direction DR1. In an embodiment, the third sub adhesion region SAA3 may be spaced apart from the first sub adhesion region SAA1 in the second direction DR2, for example. The third sub adhesive agent SAM3 may overlap with the third sub adhesion region SAA3.

The fourth sub adhesive agent SAM4 may be disposed on a fourth sub adhesion region SAA4. The fourth sub adhesion region SAA4 may be spaced apart from the third sub adhesion region SAA3 in the first direction DR1. The fourth sub adhesion region SAA4 may not be provided. The fourth sub adhesive agent SAM4 may overlap with the fourth sub adhesion region SAA4.

At least a portion of the disposition region DPA may be defined between the first sub adhesion region SAA1 and the second sub adhesion region SAA2. At least a portion of the disposition region DPA may be defined between the third sub adhesion region SAA3 and the fourth sub adhesion region SAA4. The display member DMB may be disposed on the disposition region DPA.

The display member DMB may include a plate PLT, a circuit layer CL, a light-emitting diode layer ELL, an encapsulation layer TFE, an input sensor unit ISP, a reflection protection layer RPL, and a window member WM. The display member DMB may be bendable. The display member DMB may be a flexible display member. The display member DMB may be a foldable display member. The display member DMB may be bendable with respect to a bending axis. The bending axis may be an axis parallel to the second direction DR2. A thickness of the display member DMB may be greater than a thickness of the adhesive agent AM.

The plate PLT may be disposed on the release film RLF. The plate PLT may be bendable along with the release film RLF. The plate PLT may support elements disposed above the plate PLT. The plate PLT may include metal. The plate PLT may have good thermal conductivity. The plate PLT may transfer heat emitted from an upper portion of the plate PLT to a lower portion of the plate PLT.

The plate PLT may have a bending slit and a bending grid defined therein. Accordingly, the plate PLT may be bendable with respect to the bending axis. Detailed configurations of the plate PLT will be separately described in detail with references to drawings.

The circuit layer CL may be disposed on the plate PLT. The circuit layer CL may transfer a signal. The signal transferred by the circuit layer CL may be an electric signal. The circuit layer CL may include a plurality of transistors. The plurality of transistors may transfer a signal.

The light-emitting diode layer ELL may be disposed on the circuit layer CL. The light-emitting diode layer ELL may emit light. The light-emitting diode layer ELL may receive an electric signal from the circuit layer CL to emit light. The light-emitting diode layer ELL may include a plurality of light-emitting diodes which emit light. The plurality of light-emitting diodes of the light-emitting diode layer ELL may receive a signal from the plurality of transistors of the circuit layer CL to emit light.

The encapsulation layer TFE may be disposed on the light-emitting diode layer ELL. The encapsulation layer TFE may cover the plurality of light-emitting diodes. The encapsulation layer TFE may seal off the plurality of light-emitting diodes and protect the plurality of light-emitting diodes from external oxygen or moisture.

The circuit layer CL, the light-emitting diode layer ELL, and the encapsulation layer TFE may compose of a display panel. The display panel may show an image. The display panel may be a flexible display panel.

The input sensor unit ISP may be disposed on the encapsulation layer TFE. The input sensor unit ISP may detect an input applied from outside. The input sensor unit ISP may include at least any one of a resistive film type input sensor, a capacitive input sensor, an optic sensor, an electromagnetic resonance type input sensor, an ultrasonic type input sensor, and an infrared wave type input sensor.

The reflection protection layer RPL may be disposed on the input sensor unit ISP. The reflection protection layer RPL may reduce light reflectivity of external light incident from an upper side of the window member WM. The reflection protection layer RPL may include at least any one of a color filter layer and a polarizing film.

The window member WM may be disposed on the reflection protection layer RPL. The window member WM may allow transmission of incident light. Detailed configurations of the window member WM will be separately described in detail with references to drawings.

The adhesive part AP may overlap with the adhesion region AA. The adhesive part AP may be spaced apart from the release film RLF by a first spacing distance SD1. The first spacing distance SD1 may be a thickness of the adhesive agent AM. The first spacing distance SD1 may be greater than or equal to 15 micrometers and smaller than or equal to 35 micrometers. However, the first spacing distance SD1 is not limited to the range of greater than or equal to 15 micrometers and smaller than or equal to 35 micrometers.

The first sub adhesive part SAP1 may overlap with the first sub adhesive area SAA1. The second sub adhesive part SAP2 may overlap with the second sub adhesion region SAA2. The third sub adhesive part SAP3 may overlap with the third sub adhesion region SAA3. The fourth sub adhesive part SAP4 may overlap with the fourth sub adhesion region SAA4.

The inclined part IP may include a plurality of sub inclined parts SIP1, SIP2, SIP3, SIP4. The inclined part IP may extend in a direction intersecting with the release film RLF. The inclined part IP may extend in a direction intersecting with the release film RLF and in the second direction DR2. The inclined part IP may be inclined to have an angle of inclination. The angle of inclination of the inclined part IP may be an angle between the inclined part IP and the release film RLF.

A first sub inclined part SIP1 may have one side contacting the first sub adhesive part SAP1. The first sub inclined part SIP1 may have another side contacting the spacing part SP. The first sub inclined part SIP1 may extend in a first sub inclination direction intersecting with the release film RLF. The first sub inclined part SIP1 may further extend in the second direction DR2.

A second sub inclined part SIP2 may have one side contacting the second sub adhesive part SAP2. The second sub inclined part SIP2 may have another side contacting the inclined part SP. The second sub inclined part SIP2 may extend in a second sub inclination direction intersecting with the release film RLF. The second sub inclined part SIP2 may further extend in the second direction DR2. The first sub inclination direction and the second sub inclination direction may intersect with each other.

A third sub inclined part SIP3 may have one side contacting the third sub adhesive part SAP3. The third sub inclined part SIP3 may have another side contacting the spacing part SP. The third sub inclined part SIP3 may extend in a third sub inclination direction intersecting with the release film RLF. The third sub inclination direction and the first sub inclination direction may be parallel to each other. An extending direction of the third sub inclined part SIP3 is not limited to a direction parallel to the first sub inclination direction. In addition, the third sub inclined part SIP3 may further extend in the second direction DR2. Based on a position of the third sub inclined part SIP3, an extending direction of the third sub inclined part SIP3 may vary.

A fourth sub inclined part SIP4 may have one side contacting the fourth sub adhesive part SAP4. The fourth sub inclined part SIP4 may have another side contacting the spacing part SP. The fourth sub inclined part SIP4 may extend in a fourth sub inclination direction intersecting with the release film RLF. The fourth sub inclination direction and the second sub inclination direction may be parallel to each other. An extending direction of the fourth sub inclined part SIP4 is not limited to a direction parallel to the second sub inclination direction. In addition, the fourth sub inclined part SIP4 may further extend in the second direction DR2. Based on a position of the fourth sub inclined part SIP4, an extending direction of the fourth sub inclined part SIP4 may vary.

The spacing part SP may overlap with the disposition region DPA. The spacing part SP may be spaced part from the display member DMB. The spacing part SP may be spaced apart from the release film RLF by a second spacing distance SD2. The second spacing distance SD2 may be greater than the first spacing distance SD1. The second spacing distance D2 may be greater than a thickness of the display member DMB. The second spacing distance SD2 may be greater than or equal to 900 micrometers and smaller than or equal to 1,200 micrometers. However, the second spacing distance SD2 is not limited to the range of greater than or equal to 900 micrometers and less than or equal to 1,200 micrometers.

Because the spacing part SP is spaced apart from the display member DMB, the spacing part SP and the display member DMB may not contact each other. Accordingly, a damage on the display member DMB that may occur when the spacing part SP and the display member DMB contact each other may be prevented. The spacing part SP may protect elements disposed below from external factors. The spacing part SP may protect the display member DMB from external factors.

The protective film PTF may be formed by folding a film extending in the first direction DR1 and the second direction DR2. The film may be folded to form a spacing part SP, an inclined part IP, and an adhesive part AP. A portion where the inclined part IP and the spacing part SP of the protective film PTF contact each other may be a folded portion. A portion where the inclined part IP and the adhesive part AP of the protective film PTF contact each other may be a folded portion.

The protective film PTF may be formed by press-molding a film extending in the first direction DR1 and the second direction DR2. The film may be press-molded to form a spacing part SP, an inclined part IP, and an adhesive part AP. During formation of the protective film PTF, the protective film PTF may be heated. In case that the protective film PTF is formed by press-molding, at least a portion of the protective film PTF may extend along a curve in a cross-sectional view of the protective film PTF.

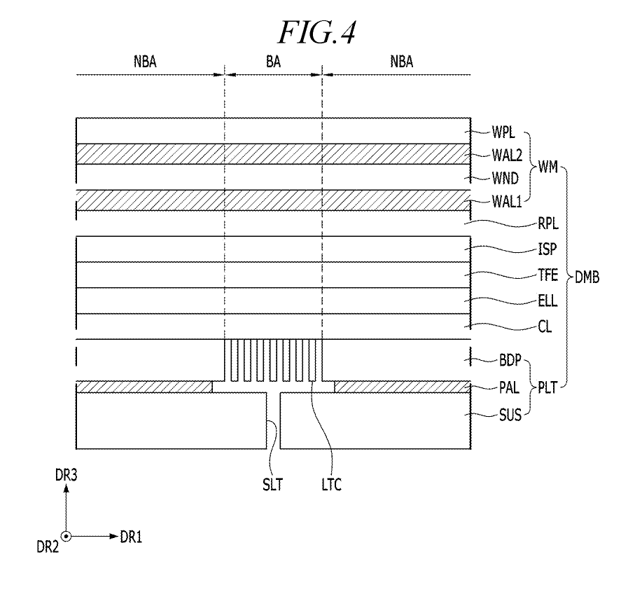

FIG. 4 is an exemplary cross-sectional view of an embodiment of a display member DMB of the disclosure.

Referring to FIG. 4, the display member DMB may have a bendable region BA and a non-bendable region NBA defined therein. The plate PLT may include a metal plate SUS, a plate adhesive layer PAL, and a bendable plate BDP. The window member WM may include a first window adhesive layer WAL1, a window WND, a second window adhesive layer WAL2, and a window protection layer WPL.

The bendable region BA may be bendable. The bendable region BA may extend in a bending direction. The bendable region BA may extend from one side of the display member DMB to another side of the display member DMB in the bending direction. The bending direction may be a direction parallel to a bendable axis. The bending direction may be a second direction DR2. The display member may have a bendable region BD defined therein to allow folding of the display member DMB. The display member DMB may be a foldable display member.

The non-bendable region NBA may not be bendable. The non-bendable region NBA may be defined as a portion that is not the bendable region BA. The display member DMB may have two non-bendable regions NBA defined therein with the bendable region BA therebetween. Incase that the display member DMB is folded, the two non-bendable regions NBA may face each other.

A bending slit SLT may be defined in the metal plate SUS. The metal plate SUS may be a metal plate including metal. The metal included in the metal plate SUS may be a non-magnetic metal. The metal plate SUS may include stainless steel.

The bending slit SLT may be a slit extending in the bendable direction. The bending slit may be defined along the bending direction to allow bending of the plate PLT without having the metal plate SUS bent. The bending slit SLT may be a slit extending from one side of the metal plate SUS to another side. Substantially, the metal plate SUS may be two metal plates spaced apart from each other with the bending slit SLT therebetween.

The plate adhesive layer PAL may be disposed on the metal plate SUS. The plate adhesive layer PAL may attach members disposed below and above. The plate adhesive layer PAL may attach a metal plate SUS and a bendable plate BDP. At least a portion of the plate adhesive layer PAL may overlap with the non-bendable region NBA. The plate adhesive layer PAL may include pressure-sensitive adhesive agent.

The bendable plate BDP may be disposed on the plate adhesive layer PAL. The bendable plate BDP may have a bending lattice LTC defined therein. The bendable plate BDP may have a bending lattice LTC defined therein to be bend. The bendable plate BDP may be foldable.

The bendable plate BDP may include a composite material. The bendable plate BDP may include a polymer matrix. The bendable plate BDP may include a carbon fiber reinforced material. The bendable plate BDP may include carbon fiber reinforced plastic.

The bending lattice LTC may overlap with the bendable region BA. The bending lattice LTC may have a plurality of opening areas defined therein. Because the plurality of opening areas are defined in the bending lattice LTC, the bending lattice LTC may be flexible. Accordingly, the bending lattice LTC may be bent. In case that the bending lattice LTC is bent, the bendable plate BDP may also be bent.

The plurality of opening areas defined in the bending lattice LTC may extend in the bending direction. Therefore, the bending lattice LTC may be more easily bent around the bending axis.

The window member WM may include a first window adhesive layer WAL1, a window WND, a second window adhesive layer WAL2, and a window protection layer WPL.

The first window adhesive layer WAL1 may be disposed on the reflection protection layer RPL. The first window adhesive layer WAL1 may attach members disposed below and above. The first window adhesive layer WAL1 may attach the reflection protection layer RPL and the window WND. The first window adhesive layer WAL1 may include a pressure-sensitive adhesive agent.

The window WND may be disposed on the first window adhesive layer WAL1. The window WND may include glass. The glass included in the window WND may be tempered glass. The window WND may allow transmission of incident light. The window WND may be flexible. Therefore, the window WND may be bendable.

A thickness of the window WND may be greater than or equal to 20 micrometers and smaller than or equal to 200 micrometers. Because the window WND has a thin thickness, it may be bendable. In case that the thickness of the window WND is smaller than 20 micrometers, the window WND may lack durability. Accordingly, the window WND may be easily damaged. In case that a thickness of the window WND is greater than or equal to 200 micrometers, the window WND may not be sufficiently flexible. Therefore, the window WND may not be sufficiently bendable. In an embodiment, the bent window WND may have a relatively large curvature, for example.

The second window adhesive layer WAL2 may be disposed on the window WND. The second window adhesive layer WAL2 may attach members disposed below and above. The second window adhesive layer WAL2 may attach the window WND and the window protection layer WPL. The second window adhesive layer WAL2 may include a pressure-sensitive adhesive agent.

The window protection layer WPL may be disposed on the second window adhesive layer WAL2. The window protection layer WPL may protect the window WND. The window protection layer WPL may be disposed on the window WND to protect the window WND from external factors.

The window protection layer WPL may protect a user from the window WND. The window WND may include tempered glass. Accordingly, in case that the window WND is damaged, it may shatter into fragments. In case that the window WND is shattered, a user may be exposed to danger due to the damaged window WND. In case that the window protection layer WPL is disposed, the shattered fragments of the damaged window WND may be prevented. As a result, a user may be protected by the window protection layer WPL.

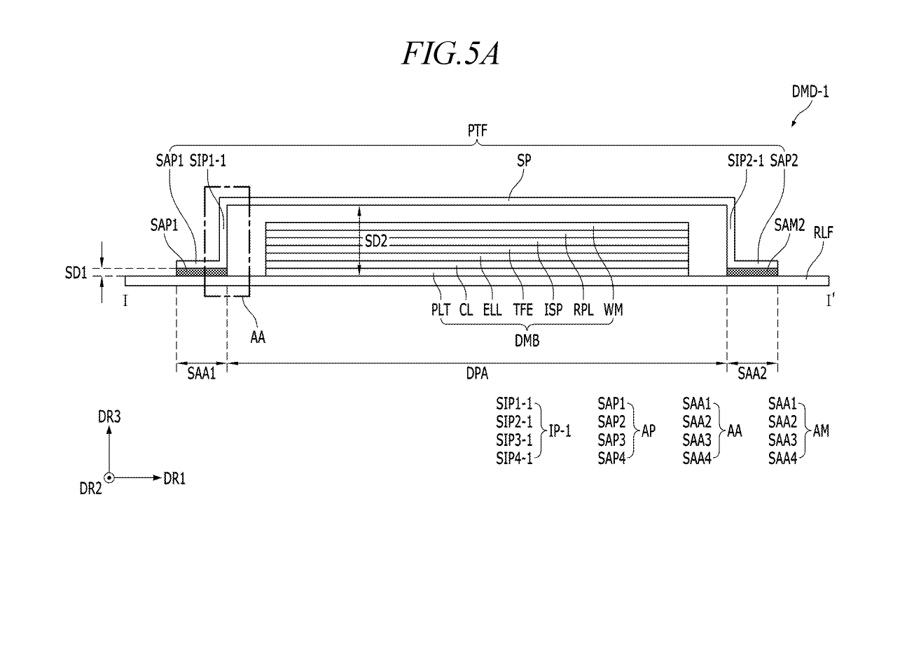

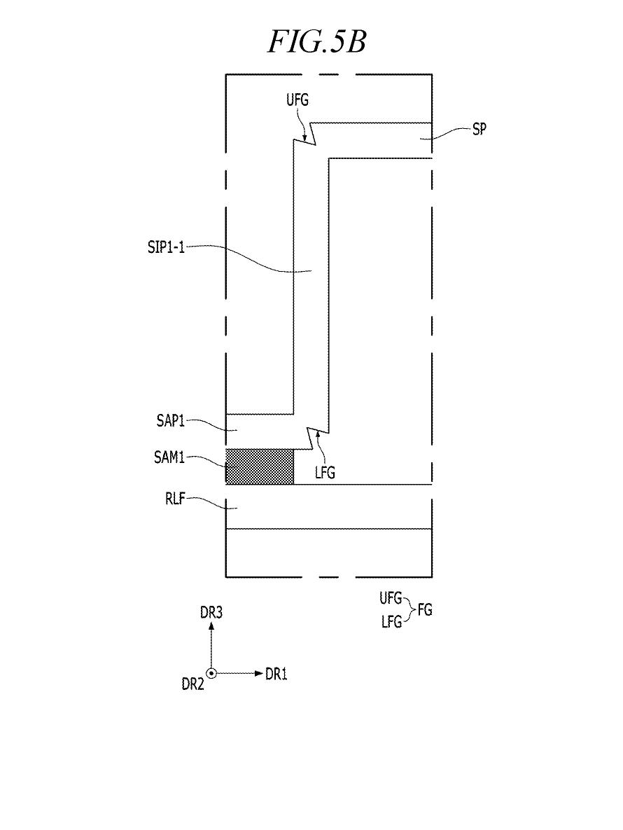

FIG. 5A is an exemplary cross-sectional view of a display module DMD-1. FIG. 5B is an exemplary magnified view of the AA area shown in FIG. 5A.

Referring to FIG. 5A, the inclined part IP-1 may extend in a direction perpendicular to the release film RLF. The inclined part IP-1 may extend in the third direction DR3. An inclination angle of the inclined part IP-1 may be 90 degrees. In case that the inclination angle of the inclined part IP-1 becomes greater, a distance between the release film RLF and the spacing part SP may become greater. Therefore, a thicker display member DMB may be disposed.

The first sub inclined part SIP1-1 and the second sub inclined part SIP2-1 may extend in the third direction DR3. The first sub inclination direction and the second sub inclination direction may be the third direction DR3. The first sub inclination direction and the second sub inclination direction may be parallel to each other.

Although FIG. 5A only illustrates the first sub inclined part SIP1-1 and the second sub inclined part SIP2-1, the third sub inclined part SIP3-1 and the fourth sub inclined part SIP4-1 may also extend in the third direction DR3. The third sub inclination direction and the fourth sub inclination direction may also be the third direction DR3. The third sub inclination direction and the fourth sub inclination direction may also be parallel to each other.

Referring to FIG. 5B, a folding groove FG may be defined in the protective film PTF. The folding groove FG may include at least any one of a lower folding groove LFG and an upper folding groove UFG. The folding groove FG may extend in the second direction DR2.

Although FIG. 5B illustrates a folding groove FG only in proximity of the first sub inclined part SIP1-1, a position of the upper folding groove UFG is not limited thereto. The folding groove FG may be defined in proximity of the second sub inclined part SIP2-1, the third sub inclined part SIP3-1, and the fourth sub inclined part SIP4-1. The folding groove FG may be defined in proximity of the inclined part IP-1.

The folding groove FG may facilitate easier folding of the protective film PTF. The folding groove FG may be defined to allow more easily folding of the protective film PTF. Therefore, the inclined part IP-1 may extend in the third direction DR3 and the second direction DR2, and an inclination angle of the inclined part IP-1 may be 90 degrees.

The folding groove FG may be formed by forming a score with a depth smaller than the thickness of the protective film PTF and folding the protective film PTF. The folding groove FG may be defined as at least any one of a portion where the inclined part IP-1 and the adhesive part AP contact each other, and a portion where the inclined part IP-1 and the spacing part SP contact each other.

The lower folding groove LFG may be defined in a portion where the inclined part IP-1 and the adhesive part AP contact each other. The lower folding groove LFG may be defined on a lower surface of the protective film PTF.

The upper folding groove UFG may be defined in a portion where the inclined part IP-1 and the spacing part SP contact each other. The upper folding groove UFG may be defined on an upper surface of the protective film PTF.

However, the folding groove FG is merely to assist in an increase in the inclination angle of the inclined part IP-1, an inclination angle of the inclined part IP-1 is not set to be 90 degrees due to the folding groove FG. Even in case of formation of the folding groove FG, the inclination angle of the inclined part IP-1 may be less than 90 degrees. In addition, even in case that the folding groove FG is not formed, the inclination angle of the inclined part IP-1 may be set to be 90 degrees.

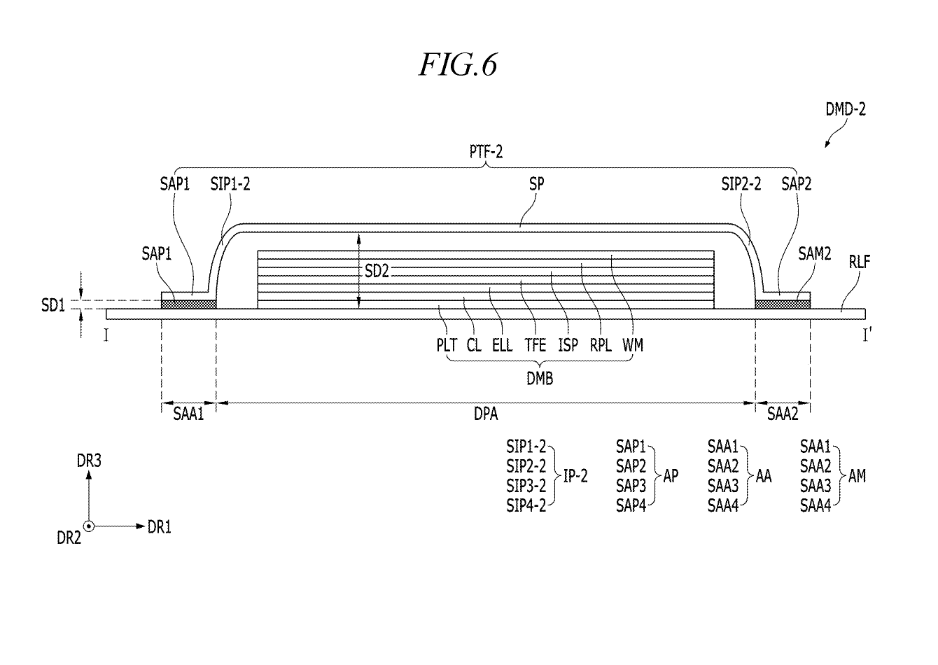

FIG. 6 is an exemplary cross-sectional view of the display module DMD-2.

Referring to FIG. 6, the inclined part IP-2 may extend along a curve. The protective film PTF-2 may be formed by press-molding. The inclined part IP-2 may extend along the curve to increase wear resistance of the protective film PTF-2.

Although FIG. 6 illustrates the first sub inclined part SIP1-2 and the second sub inclined part SIP2-2 only, a third sub inclined part SIP3-2 and a fourth sub inclined part SIP4-2 may also extend along a curve.

Although FIG. 6 illustrates that the inclined part IP-2 extends along an outwardly convex curve, a shape of the inclined part IP-2 is not limited thereto. The inclined part IP-2 may extend along an inwardly convex curve. The inclined part IP-2 may extend along a wave-shape curve.

Hereinafter, a method for manufacturing a display module in an embodiment will be described.

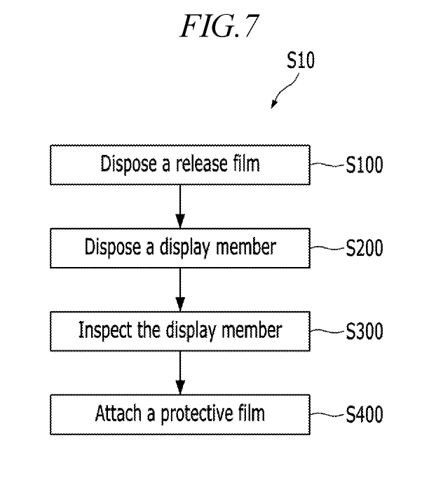

FIG. 7 is an exemplary flow chart of an embodiment of a method S10 for manufacturing a display module according to the disclosure.

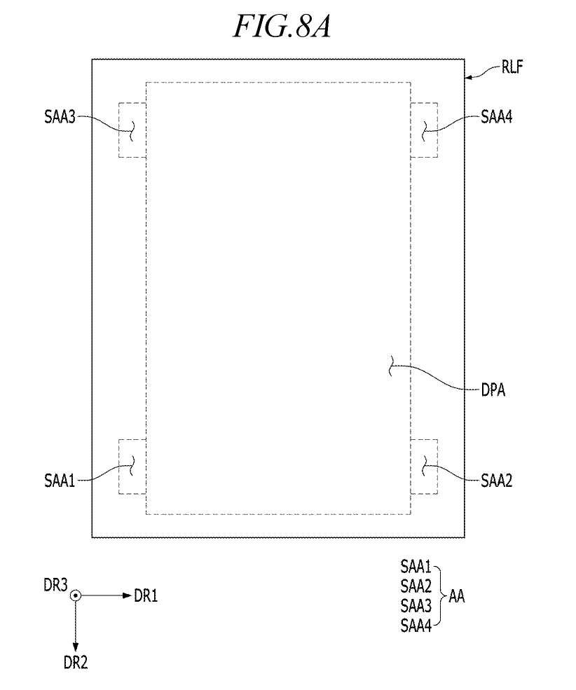

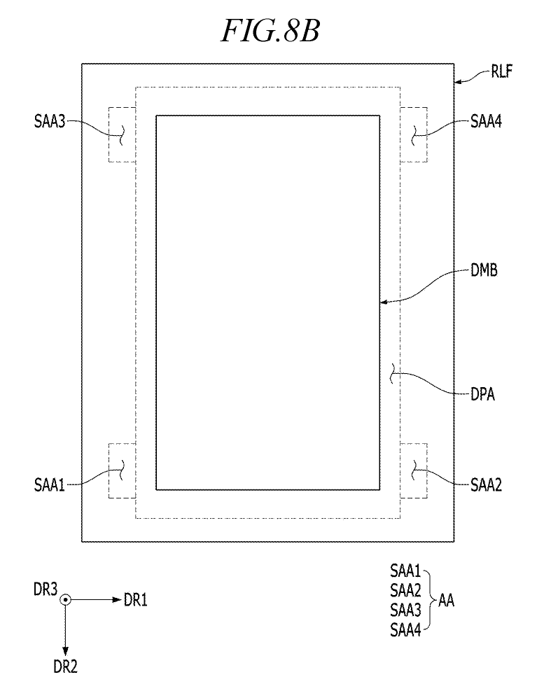

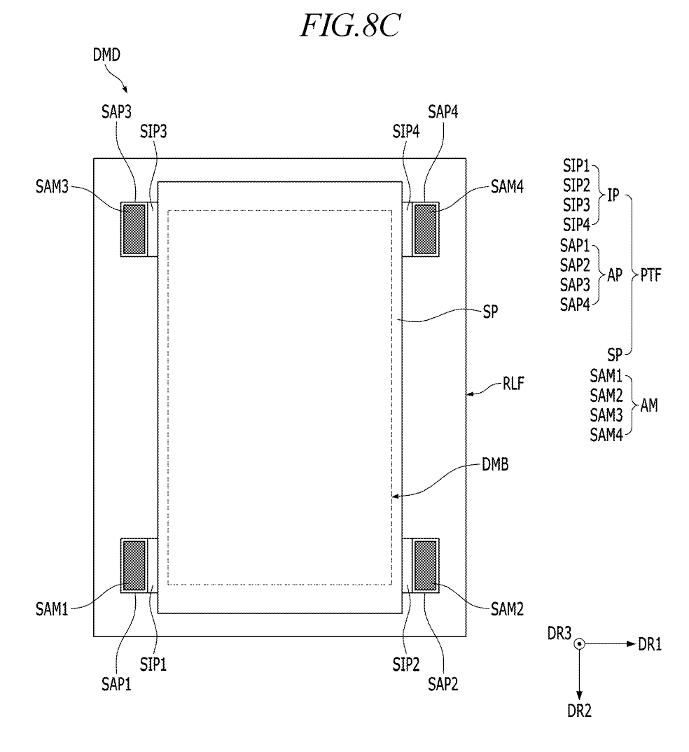

FIGS. 8A-8C are schematic top views illustrating an embodiment of an operation of method for manufacturing a display module of the disclosure.

Referring to FIG. 7, the method S10 for manufacturing a display module may include disposing a release film, disposing a display member S200, inspecting the display member S300, and attaching the protective film S400.

Referring to FIGS. 7 and 8A, in an operation S100 of the disposing a release film, a release film RLF may be disposed. In the release film RLF, a disposition region DPA and an adhesion region AA may be defined. The adhesion region AA may include a plurality of sub adhesive regions SAA1, SAA2, SAA3, SAA4.

Referring to FIGS. 7 and 8B, in an operation S200 of the disposing a display member, a display member DMB may be disposed. In the display member DMB may be defined on the disposition region DPA.

In an operation S300 of the inspecting the display member, the display member DMB may be inspected. In the inspecting a display member, an image of the display member DMB may be inspected to perform evaluation of an image of the display member DMB. In an embodiment, a resolution of the display member DMB, a color reproduction of the display member DMB, and a defective pixel of the display member DMB may be inspected, for example.

The operation of S300 of the inspecting a display member may be performed after completing the operation S200 of the disposing a display member and before an operation S400 of the attaching a protective film. The operation S300 of the inspecting a display member may be performed later than the operation S200 of the disposing a display member. In addition, the operation S300 of the inspecting a display member may be performed earlier than the operation S400 of the attaching protective film.

The operation S300 of the inspecting a display member may be performed later than the operation S200 of the disposing a display member, and an image of the display member DMB disposed on the release film RLF may be inspected in the operation S300 of the inspecting the display member.

The operation S300 of the inspecting the display member may be performed earlier than the operation S400 of the attaching a protective film, the protective film may not be disposed on the display member DMB in the inspecting a display member. Therefore, there may be no other elements disposed between an image inspection device which inspect an image of the display member DMB and the display member DMB. As a result, in the inspecting the display member S300, evaluation about an image of the display member DMB may be more accurately performed.

Referring to FIGS. 7 and 8C, in the operation S400 of the attaching a protective film, an adhesive agent AM and the protective film PTF may be disposed. The adhesive agent AM may be disposed on the adhesion region AA. The protective film PTF may contact the adhesive agent AM.

While illustrative embodiments of the disclosure have been described above, anyone ordinarily skilled in the art to which the disclosure pertains shall appreciate that there may be a variety of modifications and permutations of the disclosure without departing from the technical ideas and scopes of the disclosure that are defined in the appended claims. Moreover, it shall be appreciated that the disclosed embodiments are not intended to restrict the disclosure thereto and that every technical idea within the appended claims and their equivalents is interpreted to be included in the scope of the disclosure.

What is claimed is:

1. A display module comprising:
a release film in which a disposition region and an adhesion region are defined,
an adhesive agent disposed on the adhesion region;
a display member comprising:
a circuit layer comprising:
a plurality of transistors configured to transmit a signal and disposed on the disposition region;
a light-emitting diode layer comprising a plurality of light-emitting diodes configured to receive the signal from the plurality of transistors to emit light and disposed on the circuit layer; and
an input sensor unit disposed on the light-emitting diode layer and configured to detect an input applied from outside; and
a protective film comprising:
an adhesive part overlapping with the adhesion region to contact the adhesive agent;
a spacing part overlapping with the disposition region and spaced apart from the display member; and
an inclined part including one side contacting the adhesive part and another side contacting the spacing part.

2. The display module of claim 1,
wherein the adhesion region comprises a first sub adhesion region and a second sub adhesion region spaced apart from the first sub adhesion region in a first direction,
wherein at least a portion of the disposition region is defined between the first sub adhesion region and the second sub adhesion region,
wherein the adhesive agent comprises a first sub adhesive agent disposed on the first sub adhesion region, and a second sub adhesive agent disposed on the second sub adhesion region.

3. The display module of claim 2,
wherein the adhesive part comprises:
a first sub adhesive part overlapping with the first sub adhesion region; and
a second sub adhesive part overlapping with the second sub adhesion region,
wherein the inclined part comprises:
a first sub inclined part having one side contacting the first sub adhesive part and another side contacting the spacing part; and
a second sub inclined part having one side contacting the second sub adhesive part and another side contacting the spacing part, the second sub inclined part being spaced apart from the first sub inclined part.

4. The display module of claim 3,
wherein the adhesion region further comprises a third sub adhesion region spaced apart from the first sub adhesion region in a direction different from the first direction and spaced apart from the second sub adhesion region,
wherein the adhesive agent further comprises a third sub adhesive agent disposed on the third sub adhesion region,
wherein the adhesive part further comprises a third sub adhesive part overlapping with the third sub adhesion region, and
wherein the inclined part further comprises a third sub inclined part having one side contacting the third sub adhesive part and another side contacting the spacing part.

5. The display module of claim 3,
wherein the protective film has a folding groove defined therein, and
wherein the folding groove is defined as at least any one of a portion where the inclined part and the adhesive part contact each other, and a portion where the inclined part and the spacing part contact each other.

6. The display module of claim 3,
wherein the first sub inclined part extend in a first sub inclination direction intersecting with the release film,
wherein the second sub inclined part extends in a second sub inclination direction intersecting with the release film, and
wherein the first sub inclination direction and the second sub inclination direction intersect with each other.

7. The display module of claim 3,
wherein the display member has a bendable region, which may be bent, defined therein.

8. The display module of claim 7,
wherein the display module further comprises a window member disposed on the input sensor unit, and
wherein the window member comprises a window comprising glass and being bendable, and a window protection layer disposed on the window.

9. The display module of claim 8,
wherein a thickness of the window is greater than or equal to 20 micrometers and smaller than or equal to 200 micrometers.

10. The display module of claim 9,
wherein the glass comprised in the window is a tempered glass.

11. The display module of claim 7,
wherein the display member further comprises a plate contacting the release film and disposed between the release film and the circuit layer.

12. The display module of claim 11,
wherein the bendable region extends in a bendable direction, and
wherein the plate has a bendable slit extending in the bendable direction defined therein.

13. A protection member comprising:
a release film in which a disposition region and an adhesion region are defined;
an adhesive agent disposed on the adhesion region; and
a protective film disposed on the release film, the protective film comprising:
an adhesive part overlapping with the adhesion region, contacting the adhesive agent, and spaced apart from the release film by a first spacing distance;
a spacing part overlapping with the disposition region and spaced apart from the release film by a second spacing distance greater than the first spacing distance; and
an inclined part including one side contacting the adhesive part and another side contacting the spacing part, and
wherein an adhesive force between the adhesive agent and the protective film is greater than an adhesive force between the adhesive agent and the release film.

14. The protection member of claim 13,
wherein the adhesion region comprises a first sub adhesion region and a second sub adhesion region defined to be spaced apart from the first sub adhesion region in a first direction,
wherein at least a portion of the disposition region is defined between the first sub adhesion region and the second sub adhesion region, and
wherein a first sub adhesive agent is disposed on the first sub adhesion region, and a second sub adhesive agent is disposed on the second sub adhesion region.

15. The protection member of claim 14,
wherein the adhesive part comprises a first sub adhesive part overlapping with the first sub adhesion region, and a second sub adhesive part overlapping with the second sub adhesion region,
wherein the inclined part comprises a first sub inclined part having one side contacting the first sub adhesive part and another side contacting the spacing part, and a second sub inclined part having one side contacting the second sub adhesive part and another side contacting the spacing part and spaced apart from the first sub inclined part.

16. The protection member of claim 15,
wherein the adhesion region further comprises a third sub adhesion region spaced apart from the first sub adhesion region in a direction different from the first direction and spaced apart from the second sub adhesion region,
wherein the adhesive agent further comprises a third sub adhesive agent disposed on the third sub adhesion region,
wherein the adhesive part further comprises a third sub adhesive part overlapping with the third sub adhesion region, and
wherein the inclined part further comprises a third sub inclined part having one side contacting the third sub adhesive part and another side contacting the spacing part.

17. The protection member of claim 15,
wherein the protective film has a folding groove defined therein, and
wherein the folding groove is defined in at least any one of a portion where the inclined part and the adhesive part contact each other and a portion wherein the inclined part and the spacing part contact each other.

18. The protection member of claim 15,
wherein the first sub inclined part extends in a first sub inclination direction intersecting with the release film,
wherein the second sub inclined part extends in a second sub inclination direction intersecting with the release film, and
wherein the first sub inclination direction and the second sub inclination direction intersect with each other.

19. A method for manufacturing a display module, the method comprising:
disposing a release film having a disposition region and an adhesion region defined therein;
disposing a display member comprising a circuit layer comprising a plurality of transistors configured to transmit a signal, a light-emitting diode layer comprising a plurality of light-emitting diodes and disposed on the circuit layer, and an input sensor unit disposed on the light-emitting diode layer and configured to detect an input applied from outside; and
attaching a protective film to dispose an adhesive agent on the adhesion region so that the protective film includes at least a portion contacting the adhesive agent,
wherein the protective film comprises an adhesive part overlapping with the adhesion region and contacting the adhesive agent, a spacing part overlapping with the disposition region and spaced apart from the display member, and an inclined part extending in a direction intersecting with the release film.

20. The method for manufacturing a display module of claim 19, further comprising inspecting the display member to inspect an image of the display member,
wherein the inspecting the display member is performed after the disposing the display member and before the attaching the protective film.
